(19) United States
(12) Patent Application Publication
(10) Pub. No.: US 2014/0084084 A1
(43) Pub. Date: Mar. 27, 2014

(54) DISK SPRAY DEVICE

(71) Applicants: Chiu-Hsiang Lin, Taichung City (TW); Mikhail Ankirsky, Taichung City (TW)

(72) Inventors: Chiu-Hsiang Lin, Taichung City (TW); Mikhail Ankirsky, Taichung City (TW)

(21) Appl. No.: 13/625,631

(22) Filed: Sep. 24, 2012

(51) Int. Cl. B05B 7/00

(52) U.S. Cl. CPC B05B 7/00
USPC 239/418

(57) ABSTRACT

A disk spray device includes a shell having a top air inlet and an annular air outlet, a fan for sucking air from above the device and distributing the air through the annular air outlet to generate an air cushion around the shell, and a spray tube mounted around an outer periphery of the shell and having a plurality of nozzles adjacent to the air outlet of the shell. The spray tube is adapted to be connected with a water supply device such that water running in the spray tube can be sprayed into water mist through the nozzles of the spray tube. The water mist can be further radially delivered far away by the flow of air exhausted out of the annular air outlet of the shell by the fan.

### CROSS-REFERENCE TO RELATED APPLICATION

This patent application is a continuation-in-part of U.S. patent application Ser. No. 12/959,514 filed Dec. 3, 2012 entitled “Disk Spray Device”, the entire disclosure of which is incorporated herein by reference.

### BACKGROUND OF THE INVENTION

1. Field of the Invention

The present invention relates generally to a spray device, and more specifically to a disk spray device which utilizes a fan to cover a broader area with water mist.

2. Description of the Related Art

Under a dry or hot environment, a spray device set at a predetermined height may be used to spray water mist to increase the air humidity or lower the temperature. A conventional spray device generally includes a water pipe and a plurality of nozzles connected with the water pipe for discharging water in the form of water mist. Since the water mist is usually sprayed through the nozzles, the spraying range of the water mist is limited to a small area directly in front of the nozzles. If the water mist needs to cover a wide area, the number of nozzles must be relatively increased. Furthermore, if a conventional spray device is used, the area under the mist may become wet and slippery. When people walk through the water mist, their faces, glasses or clothes can also get wet.

U.S. Pat. No. 6,257,501 disclosed a combination of the aforementioned spray device and an electric fan. Such electric fan combination can he used to generate an air flow to carry the water mist for a longer distance. However, the distribution of the water mist is still limited in the direction right in front of the fan, and thus only the area in front of the fan is humidified and/or cooled. Areas other than those in front of the fan can still be dry or hot. Besides, such combination sucks the air mainly from behind the fan. Warm air in an upper part of a building, which may be a distance above the fan combination, is hardly sucked by the fan, thus the humidity and temperature is not uniformly distributed in the building. Moreover, when the water mist is hit by the direct air flow of the fan, the droplets of the water mist will merge and form bigger droplets which will eventually fall on the floor, making the floor wet and slippery.

Thus, it is desirable to provide a spray device that can eliminate or at least mitigate the aforementioned drawbacks.

### SUMMARY OF THE INVENTION

It is the objective of the present invention to provide a disk spray device, which allows for a wider spraying range, and completely eliminates or at least significantly reduces the possibility of dampening the area underneath the water mist.

To achieve the objective of the present invention, the disk spray device provided by the present invention comprises a shell having a top air inlet and an annular air outlet, a centrifugal fan mounted in the shell for sucking air from above the device and distributing the air through the annular air outlet to generate an air cushion around the shell, and a spray tube mounted around an outer periphery of the shell and having a plurality of nozzles, facing outward, for spraying water mist above or toward the air cushion. Therefore, when the spray tube is connected to a water supply device, water running through the spray tube will be dispersed through the nozzles into the water mist. The sprayed water mist will then hit the air cushion formed by the fan, and evaporate completely. Furthermore, the water in its gaseous state will be carried away from the spraying device and humidifying/cooling a broader area surrounding the disk spray device.

The following detailed description will further explain the full scope of applications for the present invention. However, it should be understood that the detailed description and specific examples, while indicating preferred embodiments of the invention, are given by way of illustration only, since various changes and modifications within the spirit and scope of the invention will become apparent to those with the proper technical knowledge from this detailed description.

### BRIEF DESCRIPTION OF THE DRAWINGS

The present invention can be understood more fully by referring to the detailed description below, as well as the accompanying drawings. However, it must be understood that both the descriptions and drawings are given by way of illustration only; and thus do not limit the present invention.

FIG. 1 is a perspective view of a disk spray device according to a preferred embodiment of the present invention.

FIG. 2 is an exploded view of the disk spray device according to the preferred embodiment of the present invention.

FIG. 3 is another exploded view of the disk spray device according to the preferred embodiment of the present invention.

FIG. 4 is a lateral view of the disk spray device according to the preferred embodiment of the present invention.

FIG. 5 is a schematic top view of the disk spray device, showing that the air cushion is formed around the disk spray device.

FIG. 6 is a schematic lateral view of the disk spray device, showing that the air cushion is formed around the disk spray device.

FIG. 7 is a lateral view of a disk spray device according to another preferred embodiment of the present invention.

### DETAILED DESCRIPTION OF THE INVENTION

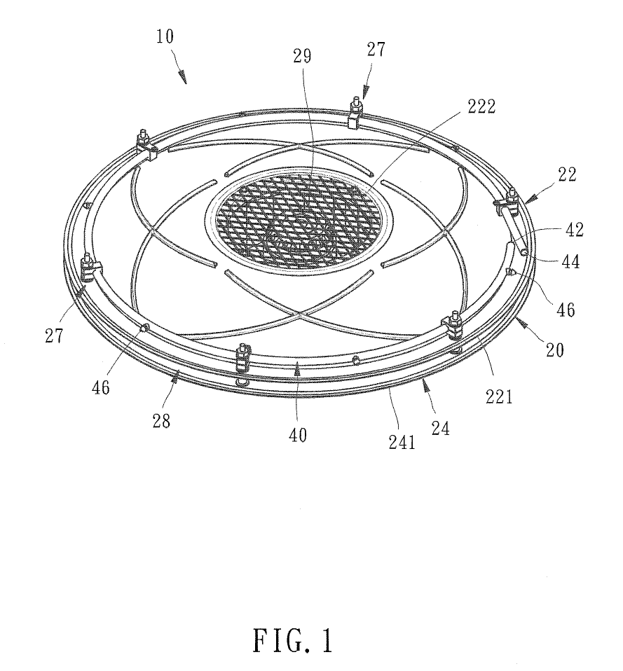

As shown in FIGS. 1 through 4, a disk spray device 10 in accordance with the preferred embodiment of the present invention comprises a shell 20, a fan 30, and a spray tube 40 with nozzles 46. The fan 30 can be a centrifugal fan or an axial fan.

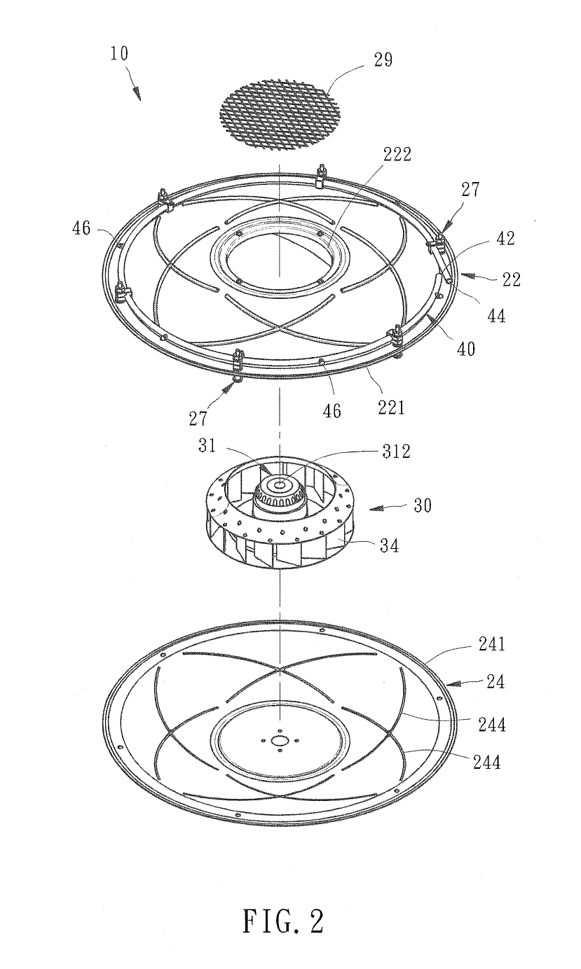

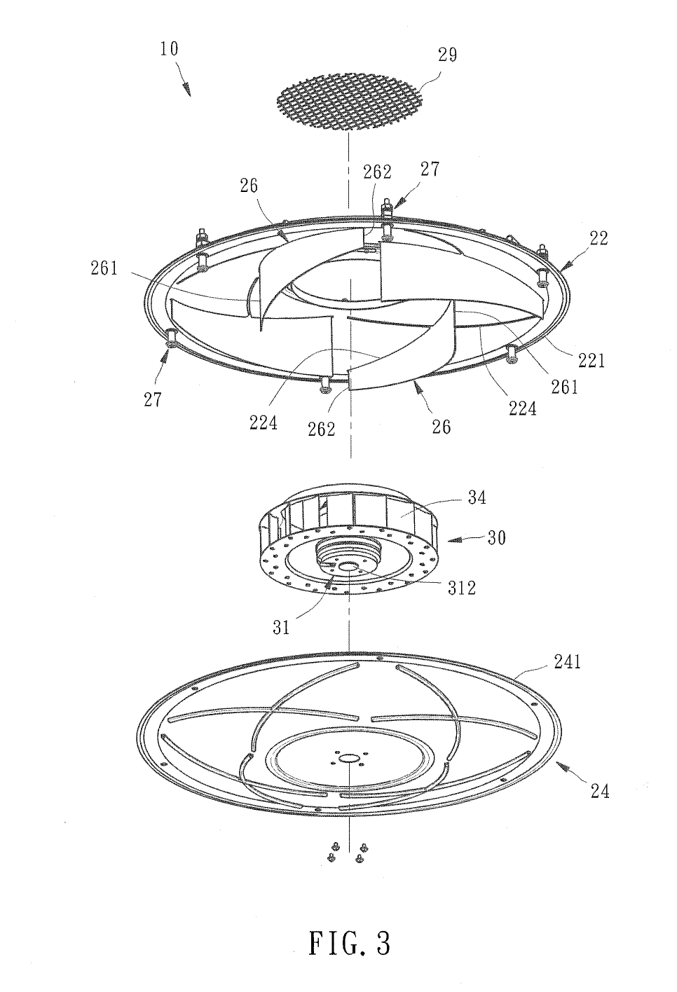

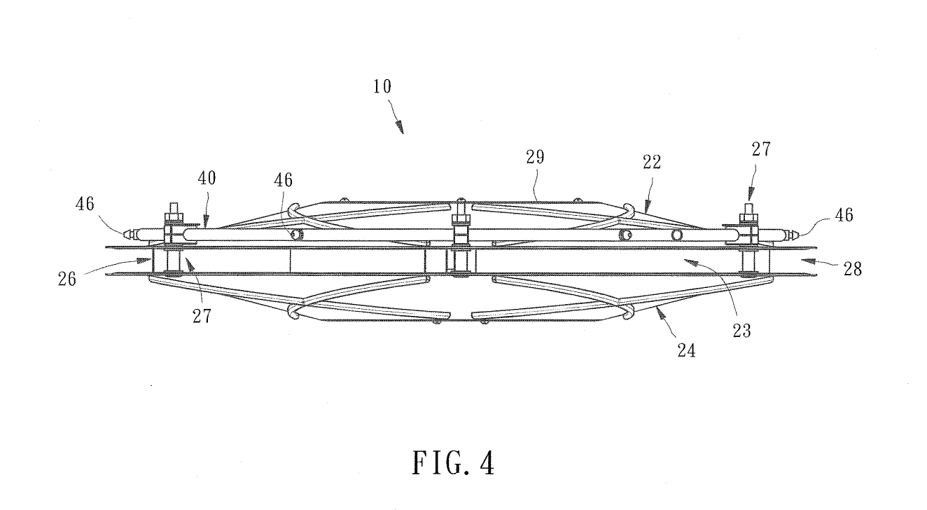

The shell 20 includes an upper shell body 22, a lower shell body 24, and four guide plates 26. The lower shell body 24 and the upper shell body 22 are similar in configuration. The upper shell body 22 has a top air inlet 222, a bottom opening 221 and four pairs of smoothly curved locating grooves 224 at the inner side, as shown in FIG. 3. The two locating grooves 224 of each pair are intersected with each other, and respectively extend in a curved matter from locations adjacent to the top air inlet 222 in clockwise and counterclockwise directions. The lower shell body 24 has a top opening 241 and is fastened to the upper shell body 22 by several fasteners 27 through a number of spacers in such a way that the openings 221 and 241 are spacedly face-to-face, and that an annular air outlet 28 is defined between the lower and upper shell bodies 22 and 24 at their peripheries. A chamber 23 is defined in the shell 20, i.e. between the upper and lower shell bodies 22 and 24 as shown in FIG. 4. The air inlet 221 is communicated with the chamber 23 in an axial direction of the shell 20, and the air outlet 28 is communicated with the chamber 23 in a radial direction of the shell 20. he resulting shape is reminiscent of a “flying saucer” with the air inlet 221 located on the top, and the air outlet 28 located around the perimeter. Further, the lower shell body 24 is provided at an inner side thereof with a plurality of locating grooves 244 corresponding in location and configuration to the locating grooves 224 of the upper shell body 22, as shown in FIG. 2. The guide plates 26 are mounted between the lower upper shell body 24 and the upper shell body 22 in such a way that the guide plates 26 are respectively inserted into four of the locating grooves 244 of the lower shell body 24 and corresponding four of the locating grooves 224 of the upper shell body 22, such that the guide plates 26 each extends in a curved manner from a first lateral side 261 thereof adjacent to the air inlet 222 to a second lateral side 262 thereof adjacent to the air outlet 28.

The centrifugal fan 30 is mounted in the shell 20, and has a motor 31 with a rotating shaft 312 extending along the axial direction corresponding to the air inlet 222, and a plurality of blades 34 arranged around and parallel to the rotating shaft 312. Additionally, external objects can be prevented from entering the shell 20 to damage the fan 30 by a screen guard 29 installed over the top of the air inlet 222 of the shell 20.

The spray tube 40 is mounted around an outer periphery of the upper shell body 22 in such a way that the spray tube 40 passes through the fasteners 27 and is located adjacent to the air outlet 28. The spray tube 40 is provided with a closed end 42, an open end 44, and a plurality of nozzles 46 adjacent to the air outlet 28 of the shell 20 for spraying water mist horizontally or in a direction slightly above the air cushion produced by the “flying saucer.”

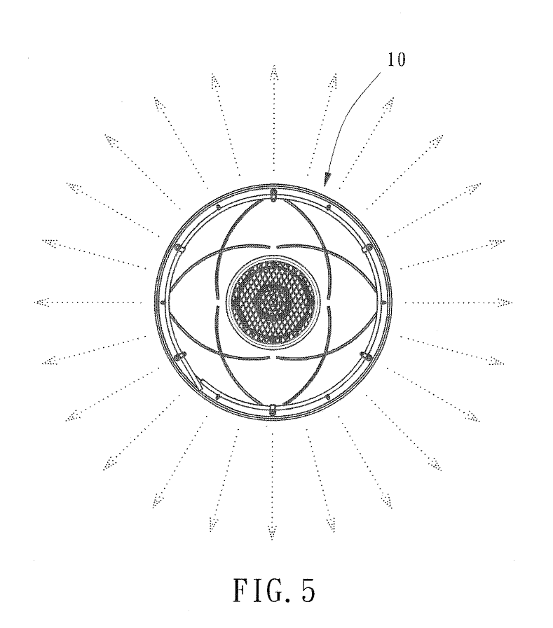

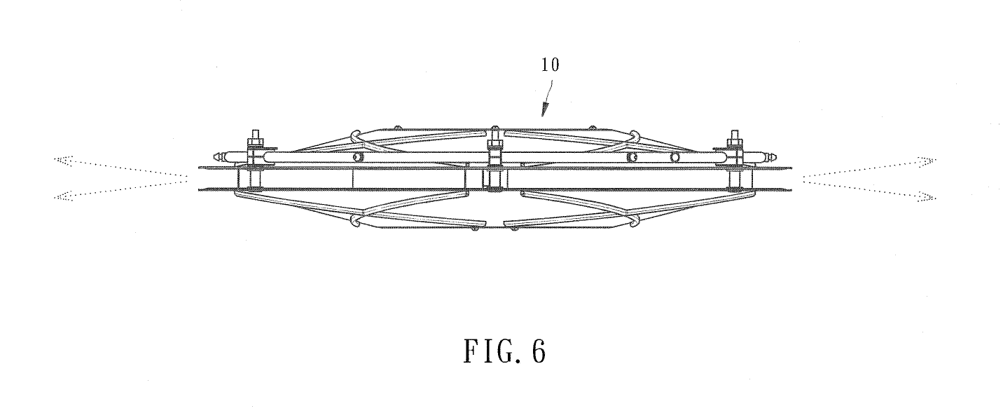

When the disk spray device 10 of the present invention is used, a water supply device (not shown) is connected with the open end 44 of the spray tube 40 such that water running in the spray tube 40 can be sprayed in the form of water mist through the nozzles 46 of the spray tube 40, and meanwhile the air is sucked by the fan 30 through the air inlet 222 into the chamber 23, and streamed by the rotation of the blades 34 towards the air outlet 28. The wind streamed by the fan 30 is guided by the guide plates 26 toward the air outlet 28 of the shell 20, and exhausted horizontally and radially, out of the chamber 23 through the air outlet 28 of the shell 20, forming an air cushion, which is a radially-distributed stream of air as indicated in dotted lines with arrows at their ends in FIGS. 5 and 6. As a result, the water mist is picked up by the air current, and substantially completely evaporates, turning the water ink a gaseous state. Therefore, the water mist substantially completely evaporates and never reaches the ground, allowing for a broader area to be humidified and cooled.

It is noted that the nozzles 46, as in FIG. 4, spray the water mist above the air cushion, an the water particles in the water mist free fall for a short distance until those water particles are carried by the air cushion and distributed further away from the disk spray device 10, evaporated into gaseous state eventually. In such a circumstance, the water particles have lower chance to collide with each other, so they can be kept in smaller size and easily evaporated. On the other hand, the water mist can also be sprayed into the air cushion. In this circumstance, the water particles have a little higher chance to collide with each other and become a bigger particle because the air stream helps mix the particles, but the particles can still be carried by the air stream and eventually evaporated. However, if the nozzles or located lower than the annular air outlet in elevation, the water mist has only a little chance, if not never, to be carried by the air cushion. Those water particles in the water mist can free fall all the way to the ground before they are totally evaporated, which may lead to two main drawbacks: only a small region is humidified/cooled for one thing and the floor can get wet and slippery for another. Thus it is advised that the spray tube be disposed not lower than the annular air outlet and the water mist be sprayed above or toward the air cushion.

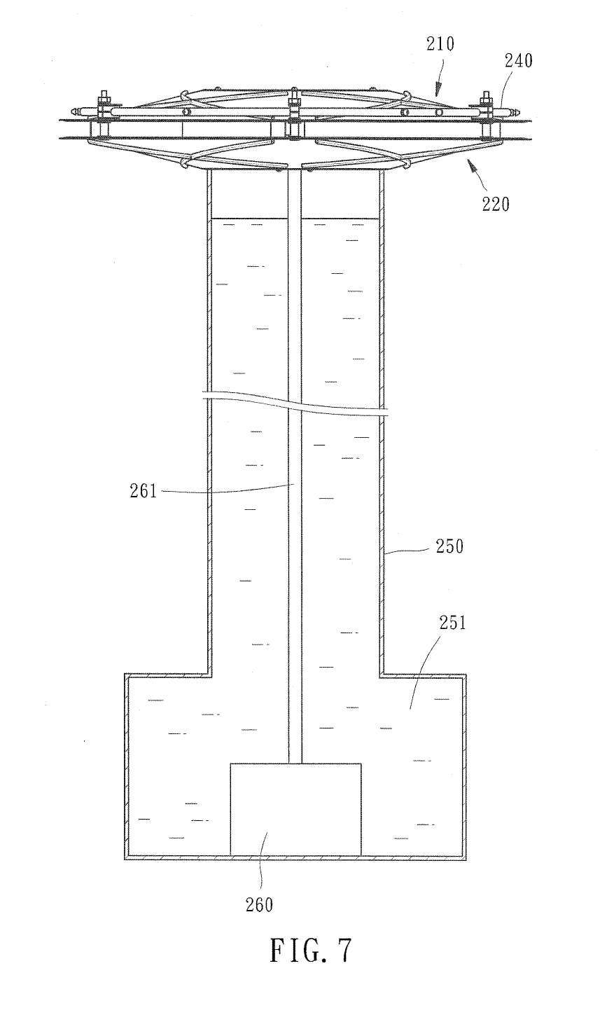

The disk spray devices 10 and 110 can be hung right under the ceiling in a building for a better humidifying/cooling effect. However, the disk spray device can still be installed and utilized otherwise. As shown in FIG. 7, a disk spray device 210 in accordance with another preferred embodiment of the present invention further includes a stand 250 supporting the shell 220. The stand 250 has a water storage chamber 251 defined therein for storage of water. A water pump 260 can be provided for pumping the water from the water storage chamber to the spray tube 240 through a water pipe 261. Such kind of disk spray devices 210 can be utilized in a place without a hanger, such as a plaza, a park or an open field. For example, the stand 250 can be set at 2-3-meter-high, and people can walk underneath the air cushion and the water mist and feel cool without getting wet.

The invention described above is capable of many modifications, and may vary. Any such variations are not to be regarded as departures from the spirit of the scope of the invention, and all modifications which would be obvious to someone with the technical knowledge are intended to be included within the scope of the following claims.

What is claimed is:

1. A disk spray device comprising:
a shell defining a chamber therein, the shell having a top air inlet communicated with the chamber in an axial direction of the shell and an annular air outlet communicated with the chamber in a radial direction of the shell;
a fan disposed in the chamber for directing air axially into the chamber through the top air inlet and radially out of the chamber through the annular air outlet to generate an air cushion around the shell, the fan is a centrifugal fan or an axial fan;
a spray tube mounted around an outer periphery of the shell and having a plurality of nozzles adjacent to the annular air outlet so that the nozzles are not lower than the annular air outlet in elevation for spraying water mist above or toward the air cushion.

2. The disk spray device as claimed in claim 1, wherein the shell includes a lower shell body having a top opening, and an upper shell body having a bottom opening and the top air inlet; the upper and lower shell bodies are coupled with each other in a manner that the top opening of the lower shell body and the bottom opening of the upper shell body are spaced from and face to each other, and the upper and lower shell bodies define an object in the shape of a “flying saucer” with the annular air outlet at their peripheries.

3. The disk spray device as claimed in claim 2, wherein the spray tube is located adjacent to the bottom opening of the upper shell body.

4. The disk spray device as claimed in claim 2, wherein a plurality of guide plates are mounted between the upper and lower shell bodies.

5. The disk spray device as claimed in claim 4, wherein the guide plates each have a first lateral side adjacent to the top air inlet and a second lateral side adjacent to the annular air outlet; each of the guide plates extends in a curved manner from the first lateral side thereof to the second lateral side thereof.

6. The disk spray device as claimed in claim 4, wherein both of the upper and lower shell bodies have a plurality of locating grooves for insertion of the guide plates.

7. The disk spray device as claimed in claim 1, comprising a screen guard installed in the top air inlet of the shell.

8. The disk spray device as claimed in claim 1, comprising a stand supporting the shell.

9. The disk spray device as claimed in claim 8, wherein the stand has a water storage chamber for storage of water, which is in fluid communication with the spray tube.

10. The disk spray device as claimed in claim 9, comprising a water pump for pumping the water from the water storage chamber to the spray tube.
